(19) United States
(12) Patent Application Publication
(10) Pub. No.: US 2007/0203842 A1
(43) Pub. Date: Aug. 30, 2007

(54) Transmission device

(75) Inventor: Tomotsugu Takamori, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/706,389

(22) Filed: Feb. 15, 2007

(30) Foreign Application Priority Data
Feb. 16, 2006 (JP) 2006-038849

(51) Int. Cl. H04L 9/00

(52) U.S. Cl. 705/52

(57) ABSTRACT

A transmitting apparatus is provided, which is capable of adding information indicating presence/absence of copyright protection information on an optical disc on which music contents are recorded in a format of digital audio, MP3, or the like. In this transmitting apparatus, when a loaded optical disc is determined to be an optical disc of music media, it is determined whether or not audio data contains copyright protection information. If it is determined that the copyright protection information is contained, copyright presence packet data is generated and is transmitted together with the audio data. If it is determined that the copyright protection information is not contained, it is determined whether or not there is a request for adding copyright protection information. If it is determined that there is the request, the copyright presence packet data is generated and is transmitted together with the audio data in the same way. If it is determined that there is not the request, copyright absence packet data is generated and is transmitted together with the audio data.

This application is based on Japanese Patent Application No. 2006-038849 filed on Feb. 16, 2006, the contents of which are hereby incorporated by reference.

### BACKGROUND OF THE INVENTION

1. Field of the Invention

The present invention relates to a transmitting apparatus such as a DVD player that is connected to a receiving apparatus such as a television receiver via an HDMI cable. More specifically, the present invention relates to a process performed by the transmitting apparatus concerning copyright protection information of audio data.

2. Description of Related Art

In these years, manufacturing techniques of liquid crystal panels or the like have been improved. As a result, a super high definition display screen has been advanced for a receiving apparatus such as a television receiver so that video data containing a large quantity of information can be displayed in high definition. In addition, there have been increasing number of television receivers recently that are equipped with HDMI (High Definition Multimedia Interface) as a digital interface for receiving video data and audio data from a DVD player or the like.

The HDMI is an interface for transmitting video data and audio data from a transmitting apparatus such as a DVD player to a receiving apparatus such as a television receiver or a projector. The HDMI is an extension of DVI (Digital Visual Interface for Computer) Ver 1.0 that is a conventional standard. More specifically, the DVI is an interface of a standard for transmitting only video data, while the HDMI is an interface of a standard that is capable of transmitting not only video data but also audio data and other data through a single cable. In addition, the HDMI supports transmission of high quality multichannel audio data and various formats of high resolution video data.

The HDMI can also be used for transmitting various types of information (monitor information, e.g., an EDID data structure or the like) by DDC (Display Data Channel) communication. The EDID (Extended Display Identification Data) includes information of resolution that the receiving apparatus can receive, audio stream information, information of a speaker that the HDMI receiving portion has. In addition, the HDMI supports transmission of video data and audio data via a single cable, so it can advantageously eliminate the inconvenience of connecting a plurality of cables. For example, in the case where DVD player outputs contents of CSS (Content Scrambling System), the HDMI is an interface of a standard approved by CPAC (Copy Protection Advisory Council).

The above-mentioned DDC is a name of a communication format, and it is also a communication line that is used for transmitting data concerning conditions for displaying video data and conditions of audio data as well as other data concerning the HDMI monitor to the DVD player. The DDC is connected to a communication line inside the DVD player and is used for establishing a line between the DVD player and the HDMI monitor. In addition, the above-mentioned CSS is a system for encoding data when recording the same and decoding the data when reproducing the same.

Usually, contents of music and pictures have a copyright, so it is necessary to protect the contents from being copied by an illegal user. A CD-DA (Compact Disc-Digital Audio) disc on which music contents are recorded in a digital audio format or a CD-ROM disc on which music contents are recorded in a format such as MP3 has copyright protection information that is inserted in the audio data in advance if copyright management of the music contents is necessary.

When an optical disc on which such music contents are recorded is loaded to a transmitting apparatus equipped with an HDMI interface for reproducing the contents, the reproduced audio data is transmitted via the HDMI to a receiving apparatus. Then, the receiving apparatus processes the received audio data and converts the data into an audio signal. This audio signal is supplied to an audio output device so that sounds are outputted from a speaker or the like. In addition, if the receiving apparatus detects that the audio data contain copyright protection information, it performs a process for preventing the audio data from being duplicated to other recording medium.

As described above, a CD-DA disc on which music contents are recorded in a digital audio format or a CD-ROM disc on which music contents are recorded in a format such as MP3 has copyright protection information that is inserted in the audio data in advance if copyright management of the music contents is necessary. As to such an optical disc, there is a case where copyright protection information was not inserted in audio data because copyright protection information was not necessary at first, but it is found later that copyright protection information is necessary. In this case, a lot of burdensome effort and time may be required for a creator of the music file to insert copyright protection information in the audio data.

WO00/63905 describes a conventional technique, in which a data transmitting apparatus (a transmitting apparatus) stores a copyright bit in a copyright field, which indicates whether or not the contents have a copyright. Then, a data packet is sent to a data reception device (a receiving apparatus). The data transmitting apparatus receives music data (audio data) from a satellite and checks which one of five types of copy control states the music data is in. The five types of copy control states include “Copy freely”, “Copy one generation”, “Copy two generations”, “No more copies”, and “Copy originally protected.”

In this conventional technique, the data transmitting apparatus checks which one of the above-mentioned five types of copy control states the music data received from the satellite is in so as to send the music data to the data reception device. However, the data transmitting apparatus cannot change the copy control information or add copy control information.

JP-A-2002-318600 describes another conventional technique, in which copyright protection information is managed for each packet. As a result, when the packet is decoded and outputted by the audio reproduction unit, it is possible to synchronize corresponding copyright protection information with a digital output so that synchronization drift between the copyright protection information and the digital audio signal can be eliminated. However, this conventional technique does not enable copyright protection information to be inserted in audio data later on a CD-DA disc on which music contents are recorded in a digital audio format or a CD-ROM disc on which music contents are recorded in a format such as MP3.

JP-A-2004-30799 describes still another conventional technique, in which text data contain information indicating the presence or absence of copyright. The information is transmitted and received together with audio data via a digital interface. However, this conventional technique also does not enable copyright protection information to be inserted in audio data later on a CD-DA disc on which music contents are recorded in a digital audio format or a CD-ROM disc on which music contents are recorded in a format such as MP3.

JP-A-2004-335024 describes still another conventional technique, in which information indicating an attribute of contents data such as the presence or absence of license data is superimposed on audio data that is transmitted. However, this conventional technique also does not enable copyright protection information to be inserted in audio data later on a CD-DA disc on which music contents are recorded in a digital audio format or a CD-ROM disc on which music contents are recorded in a format such as MP3.

### SUMMARY OF THE INVENTION

An object of the present invention is to provide a transmitting apparatus that can add information indicating the presence or absence of copyright protection information later to an optical disc on which music contents are recorded in a format such as digital audio or MP3. More specifically, the object of the present invention is to provide a transmitting apparatus that can add copyright presence packet data indicating that audio data has copyright protection information or copyright absence packet data indicating that audio data does not data have copyright protection information to a CD-DA disc on which music contents are recorded in a digital audio format or a CD-ROM disc on which music contents are recorded in a format such as MP3 or the like instead of inserting copyright protection information in the audio data when copyright protection information becomes necessary although the copyright protection information was not necessary at first.

A transmitting apparatus according to one aspect of the present invention includes a signal processing portion for reading out data recorded on an optical disc and for performing a demodulating process and a error correction process, a decoder portion for performing a predetermined decoding process by receiving data from the signal processing portion, an HDMI transmitting portion for transmitting data from the decoder portion to a receiving apparatus via an HDMI cable, a disc determining portion for detecting whether or not a loaded optical disc is an optical disc of music media, a copyright protection information presence/absence determining portion for determining whether or not audio data of the optical disc contains copyright protection information when the loaded optical disc is determined to be an optical disc of music media, a copyright protection information addition requirement determining portion for determining whether or not there is a request for adding copyright protection information when it is determined that the copyright protection information is not contained, a copyright presence packet data generating portion for generating copyright presence packet data indicating that there is a copyright when it is determined that the copyright protection information is contained or there is the request for adding copyright protection information, a copyright absence packet data generating portion for generating copyright absence packet data indicating that there is not a copyright when it is determined that there is not the request for adding copyright protection information, and a data transmitting portion for transmitting the generated copyright presence packet data or the generated copyright absence packet data from the HDMI transmitting portion to the receiving apparatus via the HDMI cable together with audio data outputted from the decoder portion.

In this structure, when an optical disc is loaded to the transmitting apparatus, the disc determining portion determines whether or not the optical disc is an optical disc of music media. If the optical disc is determined to be an optical disc of music media, the copyright protection information presence/absence determining portion determines whether or not the audio data of the optical disc contains copyright protection information.

If it is determined that the copyright protection information is contained, the copyright presence packet data generating portion generates copyright presence packet data indicating that there is a copyright. Then, the data transmitting portion transmits the copyright presence packet data from the HDMI transmitting portion together with the audio data.

When it is determined that copyright protection information is not contained, the copyright protection information addition requirement determining portion determines whether or not there is a request for adding copyright protection information. If it is determined that there is the request for adding copyright protection information, the copyright presence packet data generating portion generates copyright presence packet data indicating there is a copyright. Then, the data transmitting portion transmits the copyright presence packet data from the HDMI transmitting portion together with the audio data.

If it is determined that there is not the request for adding copyright protection information, the copyright absence packet data generating portion generates copyright absence packet data. Then, the data transmitting portion transmits the copyright absence packet data from the HDMI transmitting portion together with the audio data.

In the conventional transmitting apparatus, it is necessary to embed copyright protection information in audio data when creating a music file on an optical disc. In contrast, according to the transmitting apparatus of the present invention, it is possible to add information indicating presence or absence of copyright protection information even after the music file is created before transmission, which is convenient for a creator of the music file.

In addition, according to the transmitting apparatus of the present invention, a packet that includes information indicating presence of copyright protection information or a packet that includes information indicating absence of copyright protection information that is transmitted from the HDMI transmitting portion of the transmitting apparatus together with audio data to a receiving apparatus via the HDMI cable. The receiving apparatus can recognize that the audio data received from the transmitting apparatus has copyright protection if the packet including information indicating presence of copyright protection information is detected, while it can recognize that the audio data received from the transmitting apparatus does not have copyright protection if the packet including information indicating absence of copyright protection information is detected.

In a preferred embodiment of the present invention, the copyright presence packet data generating portion generates the copyright presence packet data by setting presence of the copyright protection information in a copyright presence/absence packet that has a packet structure including a packet header indicating a packet type, an audio data type and a data length, and including packet data to which presence or absence of copyright protection information can be set. In addition, the copyright absence packet data generating portion generates the copyright absence packet data by setting absence of the copyright protection information in the copyright presence/absence packet. In this way, copyright protection information can be easily added to the audio data later by setting presence or absence of the copyright protection information in the copyright presence/absence packet.

### BRIEF DESCRIPTION OF THE DRAWINGS

FIG. 1 is a block diagram showing a structure of a communication system including a transmitting apparatus according to an embodiment of the present invention.

FIG. 2 is a diagram showing an example of a structure of a CR packet as a copyright presence/absence packet that is used in the embodiment.

FIG. 3 is a flowchart for explaining a process concerning the copyright protection information in the transmitting apparatus of the embodiment.

### DETAILED DESCRIPTION OF PREFERRED EMBODIMENTS

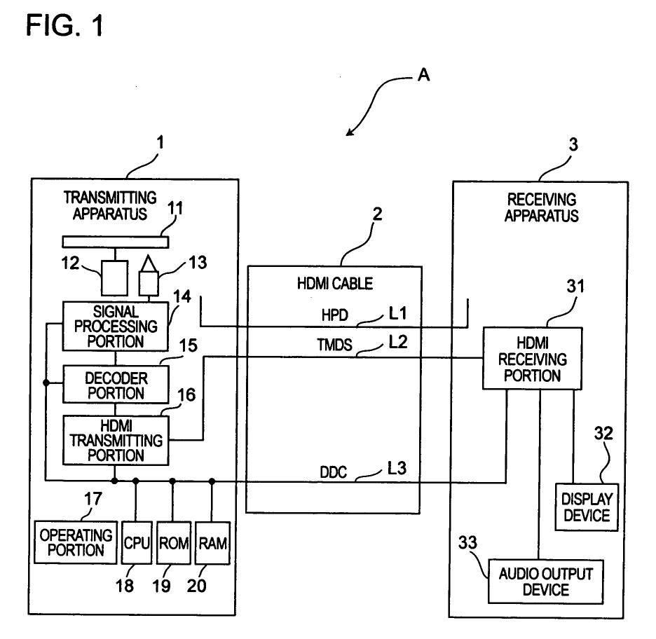

Now, an embodiment of the present invention will be described with reference to the attached drawings. FIG. 1 is a block diagram showing a structure of a communication system including a transmitting apparatus according to an embodiment of the present invention.

In FIG. 1, a communication system A is made up of a transmitting apparatus 1 such as a DVD player with an HDMI terminal that is capable of transmitting video data and audio data and a receiving apparatus 3 such as a television receiver or a projector that is connected to the transmitting apparatus 1 via an HDMI cable 2. The receiving apparatus 3 has functions of displaying images based on the video data from the transmitting apparatus 1 and outputting sounds based on the audio data from the transmitting apparatus 1.

The transmitting apparatus 1 includes an optical pickup 13 for performing optical reading of data recorded on an optical disc 11 rotated by a spindle motor 12, a signal processing portion 14 for performing a demodulating process and an error correction process on the data read out by the optical pickup 13, a decoder portion 15 for receiving data from the signal processing portion 14 for performing a predetermined decoding process, and an HDMI transmitting portion 16 for transmitting data from the decoder portion 15 to the receiving apparatus 3 via the HDMI cable 2. The receiving apparatus 3 is equipped with an HDMI receiving portion 31, a display device 32, and an audio output device 33.

The HDMI cable 2 includes a TMDS line L2 for transmitting video data and audio data from the HDMI transmitting portion 16 to the receiving apparatus 3 by a TMDS (Transition Minimized Differential Signaling) method, an HPD (Hot Plug Detector) line L1 for the transmitting apparatus 1 to detect connection or disconnection with the receiving apparatus 3, and a DDC (Display Data Channel) line L3 for the transmitting apparatus 1 to obtain condition information including display condition information from the receiving apparatus 3. In addition, the line L3 is connected to a CPU 18 for controlling each component of the transmitting apparatus 1, a ROM 19 for storing programs and data that are necessary for the CPU 18 to operate, and a RAM 20 for storing temporary data that are necessary for the CPU 18 to operate. An operating portion 17 corresponds to a remote controller or an operating portion of a main body. It is provided with a plurality of operating keys for making the transmitting apparatus 1 perform a reproduction operation, transmission operation, or other operations, and it is connected to the CPU 18.

The CPU 18 includes a disc determining portion whether or not a loaded optical disc is an optical disc of music media, a copyright protection information presence/absence determining portion for determining whether or not audio data of the optical disc contains copyright protection information when the loaded optical disc is determined to be an optical disc of music media, a copyright protection information addition requirement determining portion for determining whether or not there is a request for adding copyright protection information when it is determined that the copyright protection information is not contained, a copyright presence packet data generating portion for generating copyright presence packet data indicating that there is a copyright when it is determined that the copyright protection information is contained or there is the request for adding copyright protection information, a copyright absence packet data generating portion for generating copyright absence packet data indicating that there is not a copyright when it is determined that there is not the request for adding copyright protection information, and a data transmitting portion for transmitting the generated copyright presence packet data or copyright absence packet data from the HDMI transmitting portion to the receiving apparatus via the HDMI cable together with audio data outputted from the decoder portion.

The copyright presence packet data generating portion generates the copyright presence packet data by setting presence of the copyright protection information in a copyright presence/absence packet having a packet structure including a packet header indicating a packet type, an audio data type and a data length, and packet data for setting presence or absence of copyright protection information. In addition, the copyright absence packet data generating portion generates the copyright absence packet data by setting absence of the copyright protection information in the copyright presence/absence packet.

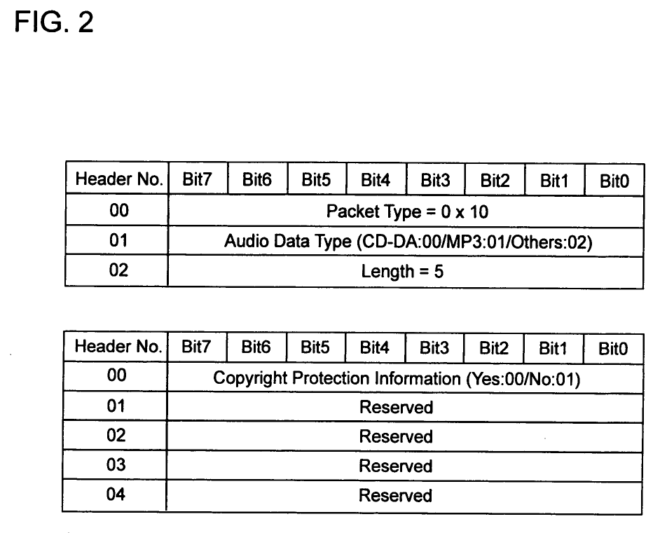

FIG. 2 is a diagram showing an example of a structure of a CR (copyright) packet as a copyright presence/absence packet that is used in this embodiment. In FIG. 2, the CR packet is made up of a packet header and packet data. The packet header contains packet type information that indicates a type of the packet, audio data type information that indicates a type of the audio data, and length information that indicates length of the packet data.

In the case of this example, the packet type is 0×10. As the audio data type information, “00” is set for the CD-DA, “01” is set for the MP3, and “02” is set for the others. Therefore, if the audio data type information is “01” for example, it is understood that the audio data type is MP3. In addition, if the length information is “5”, it indicates that the data length of the packet is 5 bytes.

Presence or absence of copyright protection information is set in Data No. 00 of the packet data in the CR packet. For example, if the copyright protection information is presence, “00” is set. If the copyright protection information is absence, “01” is set. In addition, reserved areas are assigned to Data Nos. 01-04 of packet data of the CR packet.

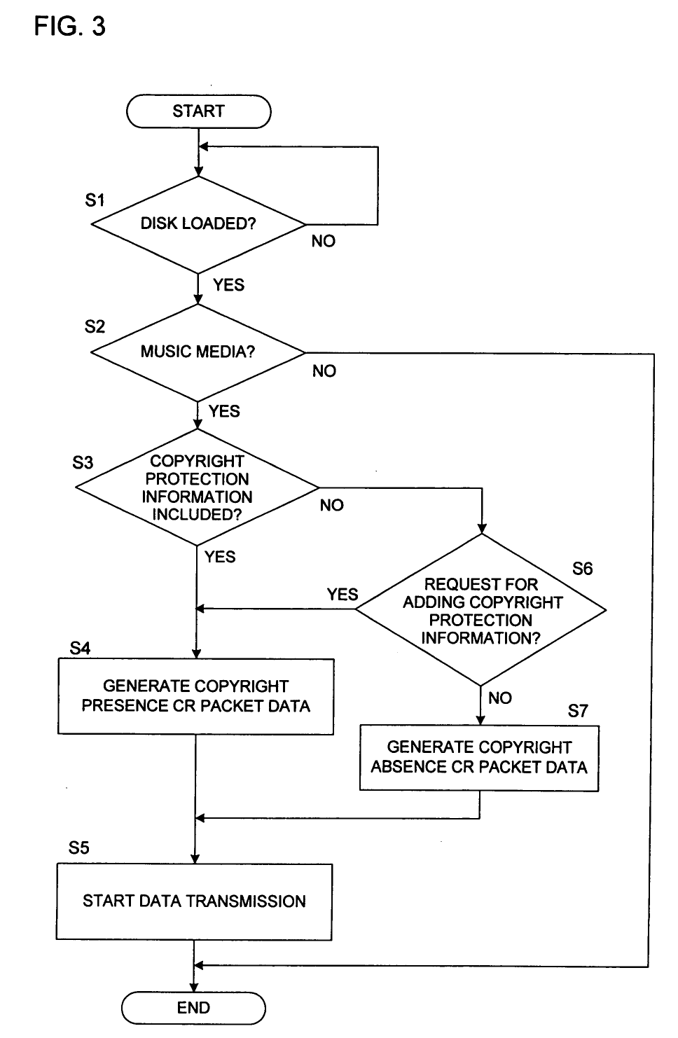

FIG. 3 is a flowchart for explaining a process concerning the copyright protection information in the transmitting apparatus of the embodiment. With reference to this flowchart and FIGS. 1 and 2, a process concerning copyright protection information in the transmitting apparatus will be described.

First, when the optical disc 11 is loaded to the transmitting apparatus 1, the CPU 18 detects that a certain optical disc is loaded (Step S1), and the disc determining portion of the CPU 18 determines whether or not the optical disc 11 is an optical disc of music media based on disc information of the optical disc 11 (Step S2). If it is determined that the optical disc 11 is an optical disc of music media, the copyright protection information presence/absence determining portion of the CPU 18 determines whether or not the audio data of the optical disc 11 contains copyright protection information (Step S3).

When it is determined that the copyright protection information is contained, the copyright presence packet data generating portion of the CPU 18 generates copyright presence CR packet data indicating that there is a copyright (Step S4). More specifically, the copyright presence packet data generating portion generates the copyright presence CR packet data by setting the copyright protection information to “00” (presence) in the CR packet (see FIG. 2) as a copyright presence/absence packet having a packet structure including a packet header indicating a packet type, an audio data type and a data length, and also including packet data for setting presence or absence of copyright protection information (Step S4).

Then, the data transmitting portion of the CPU 18 responds to a transmission instruction from the operating portion 17 and starts transmitting, from the HDMI transmitting portion 16, the audio data that is read out from the optical disc 11 by the optical pickup 13, subjected to the decoding process and the error correction process in the signal processing portion 14, and further subjected to the predetermined decoding process in the decoder portion 15, together with the CR packet containing the copyright protection information presence information (Step S5). In other words, the transmitting apparatus 1 structures the CR packet together with other packet information and transmits the same when transmitting the audio data recorded on the optical disc 11 to the receiving apparatus 3.

If it is determined that the copyright protection information is not contained in step S3, the copyright protection information addition requirement determining portion of the CPU 18 determines whether or not there is a request for adding the copyright protection information from the operating portion 17 (Step S6). If it is determined that there is the request for adding the copyright protection information, the copyright presence packet data generating portion of the CPU 18 generates copyright presence CR packet data indicating there is a copyright (Step S4).

Then, the data transmitting portion of the CPU 18 responds to a transmission instruction from the operating portion 17 and starts transmitting, from the HDMI transmitting portion 16, the audio data that is read out from the optical disc 11 by the optical pickup 13, subjected to the decoding process and the error correction process in the signal processing portion 14, and further subjected to the predetermined decoding process in the decoder portion 15, together with the CR packet containing the copyright protection information presence information (Step S5).

If it is determined that there is not the request for adding the copyright protection information in Step S6, the copyright absence packet data generating portion of the CPU 18 generates copyright absence CR packet data (Step S7). More specifically, the copyright absence packet data generating portion generates the copyright absence CR packet data by setting the copyright protection information to “01” (absence) in the CR packet (see FIG. 2) as the copyright presence/absence packet (Step S7).

Then, the data transmitting portion of the CPU 18 responds to a transmission instruction from the operating portion 17 and starts transmitting, from the HDMI transmitting portion 16, the audio data that is read out from the optical disc 11 by the optical pickup 13, subjected to the decoding process and the error correction process in the signal processing portion 14, and further subjected to the predetermined decoding process in the decoder portion 15, together with the CR packet containing the copyright protection information absence information (Step S5).

The CR packet containing the copyright protection information presence information or the CR packet containing the copyright protection information absence information transmitted from the HDMI transmitting portion 16 of the transmitting apparatus 1 together with the audio data is transmitted to the HDMI receiving portion 31 of the receiving apparatus 3 via the HDMI cable 2. The receiving apparatus 3 can recognize that there is a copyright protection for the audio data received from the transmitting apparatus 1 if the CR packet containing the copyright protection information presence information is detected, while it can recognize that there is not a copyright protection for the audio data received from the transmitting apparatus 1 if the CR packet containing the copyright protection information absence information is detected.

As described above, according to the present embodiment, it is possible to add CR packet data indicating that there is copyright protection information instead of inserting copyright protection information in audio data in the case where copyright protection information becomes necessary later although the copyright protection information was not necessary at first for a CD-DA disc on which music contents are recorded in a digital audio format or a CD-ROM disc on which music contents are recorded in a format such as MP3. Alternatively, CR packet data indicating that there is not copyright protection information can be added later. Therefore, it is possible to relieve a burden of generating information indicating presence or absence of copyright protection information for the audio data recorded on the optical disc.

The present invention can be applied to a process for adding copyright protection information to audio data when audio data is transmitted by a transmitting apparatus capable of reproducing audio data or the like recorded on an optical disc and transmitting the reproduced data.

What is claimed is:

1. A transmitting apparatus, comprising:
a signal processing portion for reading out data recorded on an optical disc and for performing a demodulating process and an error correction process;
a decoder portion for performing a predetermined decoding process by receiving data from the signal processing portion;
an HDMI transmitting portion for transmitting data from the decoder portion to a receiving apparatus via an HDMI cable;
a disc determining portion for determining whether or not a loaded optical disc is an optical disc of music media;
a copyright protection information presence/absence determining portion for determining whether or not audio data of the optical disc contains copyright protection information when the loaded optical disc is determined to be an optical disc of music media;
a copyright protection information addition requirement determining portion for determining whether or not there is a request for adding copyright protection information when it is determined that the copyright protection information is not contained;
a copyright presence packet data generating portion for generating copyright presence packet data indicating that there is a copyright when it is determined that the copyright protection information is contained or there is the request for adding copyright protection information;
a copyright absence packet data generating portion for generating copyright absence packet data indicating that there is not a copyright when it is determined that there is not the request for adding copyright protection information, and
a data transmitting portion for transmitting the generated copyright presence packet data or the generated copyright absence packet data from the HDMI transmitting portion to the receiving apparatus via the HDMI cable together with audio data outputted from the decoder portion.

2. A transmitting apparatus according to claim 1, wherein
the copyright presence packet data generating portion generates the copyright presence packet data by setting presence of the copyright protection information in a copyright presence/absence packet that has a packet structure including a packet header indicating a packet type, an audio data type and a data length, and including packet data to which presence or absence of copyright protection information can be set, and
the copyright absence packet data generating portion generates the copyright absence packet data by setting absence of the copyright protection information in the copyright presence/absence packet.

3. A transmitting apparatus, comprising:
a signal processing portion for reading out data recorded on an optical disc and for performing a demodulating process and an error correction process;
a decoder portion for performing a predetermined decoding process by receiving data from the signal processing portion;
an HDMI transmitting portion for transmitting data from the decoder portion to a receiving apparatus via an HDMI cable;
a disc determining portion for determining whether or not a loaded optical disc is an optical disc of music media;
a copyright protection information presence/absence determining portion for determining whether or not audio data of the optical disc contains copyright protection information when the loaded optical disc is determined to be an optical disc of music media;
a copyright protection information addition requirement determining portion for determining whether or not there is a request for adding copyright protection information when it is determined that the copyright protection information is not contained;
a copyright presence packet data generating portion for generating copyright presence packet data when it is determined that the copyright protection information is contained or there is the request for adding copyright protection information, the copyright presence packet data being generated by setting presence of the copyright protection information in a copyright presence/absence packet that has a packet structure including a packet header indicating a packet type, an audio data type and a data length, and including packet data to which presence or absence of copyright protection information can be set;
a copyright absence packet data generating portion for generating copyright absence packet data when it is determined that there is not the request for adding copyright protection information, the copyright absence packet data being generated by setting absence in the copyright presence/absence packet; and
a data transmitting portion for transmitting the generated copyright presence packet data or the generated copyright absence packet data from the HDMI transmitting portion to the receiving apparatus via the HDMI cable together with audio data outputted from the decoder portion.
